(19) United States
(12) Patent Application Publication
(10) Pub. No.: US 2022/0193965 A1
(43) Pub. Date: Jun. 23, 2022

(54) METHODS FOR FORMING HEAT-RESISTANT POLYURETHANE COVERS FOR GOLF BALLS

(71) Applicant: Acushnet Company, Fairhaven, MA (US)

(72) Inventors: Shawn Ricci, New Bedford, MA (US); Michael Michalewich, Norton, MA (US); Brian Comeau, Berkley, MA (US)

(73) Assignee: Acushnet Company, Fairhaven, MA (US)

(21) Appl. No.: 17/540,300

(22) Filed: Dec. 2, 2021

Related U.S. Application Data
(60) Provisional application No. 63/127,508, filed on Dec. 18, 2020.

(51) Int. Cl. B29C 45/14; A63B 37/00; C09D 175/04

(52) U.S. Cl. CPC B29C 45/14819; A63B 37/0024; C09D 175/04; A63B 37/0074; B29K 2075/00; A63B 37/0032; A63B 37/0076; A63B 37/0075; A63B 37/0033

(57) ABSTRACT

The present invention provides methods for producing golf balls having polyurethane covers and the resultant balls. Multi-piece golf balls having an inner core and outer cover with one or more intermediate layers disposed between the core and cover can be formed. The methods involve producing hydroxyl-terminated adducts and isocyanate-terminated prepolymers. Thermoset and thermoplastic polyurethane compositions can be prepared. The resulting polyurethane compositions and golf ball covers have high thermal stability and good wear-resistance and durability.

### CROSS-REFERENCE TO RELATED APPLICATIONS

This application claims the benefit of U.S. Provisional Application No. 63/127,508, filed Dec. 18, 2020, the entire disclosure of which is incorporated by reference.

### BACKGROUND OF THE INVENTION

### Field of the Invention

The present invention is directed generally to methods for producing multi-piece solid golf balls. In general, such balls contain an inner core and outer cover with one or more intermediate layers disposed between the core and cover. The cover is preferably formed from a thermally stable polyurethane composition. The methods involve preparing intermediate polyurethane prepolymers using a hydroxyl-terminated adducts.

### Brief Review of the Related Art

Both professional and amateur golfer use multi-piece, solid golf balls today. Basically, a two-piece solid golf ball includes a solid inner core protected by an outer cover. The inner core is made of a natural or synthetic rubber such as polybutadiene, styrene butadiene, or polyisoprene. The cover surrounds the inner core and may be made of a variety of materials including ethylene acid copolymer ionomers, polyamides, polyesters, and polyurethanes.

Three-piece, four-piece, and even five-piece balls have become more popular over the years. More golfers are playing with these multi-piece balls for several reasons including new manufacturing technologies, lower material costs, and desirable ball playing performance properties. Many golf balls used today have multi-layered cores comprising an inner core and at least one surrounding outer core layer. For example, the inner core may be made of a relatively soft and resilient material, while the outer core may be made of a harder and more rigid material. The “dual-core” sub-assembly is encapsulated by a single or multi-layered cover to provide a final ball assembly. Different materials are used in these golf ball constructions to impart specific properties and playing features to the ball.

For instance, ionomer compositions comprising an ethylene acid copolymer containing acid groups that are at least partially neutralized can be used to make golf ball covers. Suitable ethylene acid copolymers that may be used to form the cover layers are generally referred to as copolymers of ethylene; C₃ to C₈ α, β-ethylenically unsaturated mono-or dicarboxylic acid; and optional softening monomer. Commercially available ionomer compositions that can be used to make such covers include Surlyn@ (DuPont) and Escor@ and Iotek@ (Exxon) ionomers.

In recent years, there has been high interest in using polyurethane compositions to make golf ball covers. Basically, polyurethane compositions contain urethane linkages formed by reacting an isocyanate group (—N═C═O) with a hydroxyl group (OH). Polyurethanes are produced by the reaction of a multi-functional isocyanate with a polyol in the presence of a catalyst and other additives. The chain length of the polyurethane prepolymer is extended by reacting it with hydroxyl-terminated and amine curing agents. In practice, there are generally two basic techniques used to make the polyurethanes: a) one-shot technique, and b) prepolymer technique. In the one-shot technique, the diisocyanate, polyol, and hydroxyl-terminated chain-extender (curing agent) are reacted in one step. On the other hand, the prepolymer technique involves a first reaction between the diisocyanate and polyol compounds to produce a polyurethane prepolymer, and a subsequent reaction between the prepolymer and hydroxyl-terminated chain-extender.

The polyurethane composition is then molded into a golf ball cover. Different molding operations can be used to form the cover over the core or sub-assembly of the ball. For example, compression-molding, casting, and injection-molding processes can be used. These molding processes normally use molds having an upper mold cavity and lower mold cavity. Each mold cavity is hemispherical-shaped and one-half of the size of a finished ball. The mold cavities have interior walls with details defining the dimple pattern of the cover that will be produced. The upper and lower mold cavities are joined together under sufficient heat and pressure. The polyurethane material in the cavities encapsulates the ball subassembly and forms the cover of the ball. After the golf balls have been removed from the mold, they may be subjected to finishing steps including flash-trimming, surface-treatment, marking, and application of coatings.

One drawback, however, with using conventional polyurethane compositions to form golf ball covers is that they might, in some instances, have poor heat stability. This can lead to early softening of the polyurethane composition during the molding operation. The polyurethane composition can have poor heat-resistance. Thus, it would be desirable to have new, cost-effective, efficient methods for forming polyurethane compositions to make golf ball covers. The methods should involve making thermally stable polyurethane compositions. The present invention provides such methods. The resulting finished polyurethane cover golf balls have many advantageous features and properties including high thermal stability and good wear-resistance and durability.

### SUMMARY OF THE INVENTION

The present invention generally relates to methods for forming golf balls having polyurethane covers. The methods involve making thermally stable polyurethane compositions. Multi-piece golf balls having inner cores, outer cores, inner covers, and intermediate layers can be made.

In one embodiment, the method for forming the golf ball comprises the steps of: a) providing a golf ball sub-assembly comprising at least one core layer; b) forming a hydroxyl-terminated adduct by reacting a first isocyanate compound with a stoichiometric excess of polyol compound; c) forming an isocyanate-terminated prepolymer by reacting the hydroxyl-terminated adduct with a stoichiometric excess of a second isocyanate compound; d) reacting the isocyanate-terminated prepolymer with a hydroxyl-terminated chain extender to form a polyurethane composition; and e) forming a cover disposed about the core, the cover comprising the polyurethane composition. Preferably, the first isocyanate compound is reacted with the polyol compound at a ratio OH:NCO groups in the range of about 1:0.66 to about 1:0.85. In addition, the isocyanate-terminated prepolymer preferably has no greater than 15% unreacted NCO groups.

In one embodiment, the first and second isocyanate compounds are aliphatic isocyanates. For example, the aliphatic isocyanates can be selected from the group consisting of isophorone diisocyanate, 1,6-hexamethylene diisocyanate, 4,4′-dicyclohexylmethane diisocyanate, meta-tetramethylxylene diisocyanate, trans-cyclohexane diisocyanate, and homopolymers and copolymers and blends thereof.

In another embodiment, the first and second isocyanate compounds are aromatic isocyanates. For example, the first and second aromatic isocyanates can be selected from the group consisting of toluene 2,4-diisocyanate, toluene 2,6-diisocyanate, 4,4′-methylene diphenyl diisocyanate, 2,4′-methylene diphenyl diisocyanate, polymeric methylene diphenyl diisocyanate, p-phenylene diisocyanate, m-phenylene diisocyanate, naphthalene 1,5-diisocynate, naphthalene 2,4-diisocyanate, p-xylene diisocyanate, and homopolymers and copolymers and blends thereof.

In a further embodiment, the first isocyanate compound is an aromatic isocyanate and the second isocyanate is an aliphatic isocyanate. In yet another embodiment, the first isocyanate compound is an aliphatic isocyanate and the second isocyanate is an aromatic isocyanate. Different hydroxyl-terminated chain extenders can be used to extend the chain length of the prepolymer and build-up its molecular weight. Preferably, the chain extender is 1,4-butanediol. The polyurethane composition can comprise an ultraviolet (UV) light stabilizer. Also, a catalyst can be used to promote the reaction between the isocyanate-terminated prepolymer with the hydroxyl-terminated chain extender. The polyurethane cover can have a thickness in the range of about 0.010 to about 0.050 inches. Also, the polyurethane cover can have a a hardness in the range of about 20 to about 60 Shore D. Thermoset and thermoplastic polyurethane compositions can be made in accordance with the present invention.

In one specific example, the method comprises the steps of: a) providing a golf ball sub-assembly comprising at least one core layer; b) forming a hydroxyl-terminated adduct by reacting a first isocyanate compound with a stoichiometric excess of polyol compound; c) forming an isocyanate-terminated prepolymer by reacting the hydroxyl-terminated adduct with a stoichiometric excess of a second isocyanate compound; d) providing a lower and upper mold cavity, each mold cavity having an arcuate inner surface defining an inverted dimple pattern; e) dispensing a liquid mixture comprising the isocyanate-terminated prepolymer and hydroxyl-terminated chain-extender into the lower and upper mold cavities; f) placing the ball-subassembly into the lower or upper mold cavity containing the liquid mixture; g) bringing the lower and upper mold cavities together under sufficient pressure so the liquid mixture reacts and forms a polyurethane outer cover layer; and h) detaching the mold cavities and removing the golf ball from the mold.

In another specific example, the method comprises the steps of: a) providing a golf ball sub-assembly comprising at least one core layer; b) forming a hydroxyl-terminated adduct by reacting a first isocyanate compound with a stoichiometric excess of polyol compound; c) forming an isocyanate-terminated prepolymer by reacting the hydroxyl-terminated adduct with a stoichiometric excess of a second isocyanate compound; d) reacting the isocyanate-terminated prepolymer with a hydroxyl-terminated chain extender to form a polyurethane composition; e) providing a mold having a lower mold cavity and upper mold cavity, each mold cavity having an arcuate inner surface defining an inverted dimple pattern; so that when the upper and lower mold cavities are mated together, they define a mold having an interior spherical cavity for holding a golf ball sub-assembly; f) loading the golf ball sub-assembly into the interior spherical cavity of the mold, wherein the mold further includes two or more retractable pins for holding the golf ball within the spherical cavity; g) injecting the polyurethane composition into the spherical cavity to form a spherical cover over the golf ball sub-assembly; and h) detaching the lower and upper mold cavities and removing the golf ball from the mold.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings, in which:

FIG. 1 is a perspective view of upper and lower mold cavities that can be used to make the golf ball covers in accordance with the present invention;

FIG. 2 is a planar view of the lower mold cavity shown in FIG. 1;

FIG. 3 is a cross-sectional view of a four-piece golf ball having a dual-layered core; intermediate layer; and surrounding cover made in accordance with the present invention;

FIG. 4 is a cross-sectional view of a three-piece golf ball having a dual-layered core and surrounding cover made in accordance with the present invention; and

FIG. 5 is a perspective view of a finished golf ball having a dimpled cover made in accordance with the present invention.

### DETAILED DESCRIPTION OF THE INVENTION

The present invention relates generally to new methods for producing golf balls having a cover layer, particularly polyurethane cover layers. These methods help produce a polyurethane composition and golf ball cover having good thermal stability. The resulting polyurethane covered golf balls also have high impact durability, toughness, and wear-resistance.

Polyurethane Compositions

The golf balls of this invention include an outer cover layer made of a polyurethane composition. In general, polyurethanes contain urethane linkages formed by reacting an isocyanate group (—N═C═O) with a hydroxyl group (OH). The polyurethanes are produced by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with short-chain diols (OH—R′—OH). The resulting polyurethane has elastomeric properties because of its “hard” and “soft” segments, which are covalently bonded together. This phase separation occurs because the mainly non-polar, low melting soft segments are incompatible with the polar, high melting hard segments. The hard segments, which are formed by the reaction of the diisocyanate and low molecular weight chain-extending diol, are relatively stiff and immobile. The soft segments, which are formed by the reaction of the diisocyanate and long chain diol, are relatively flexible and mobile. Because the hard segments are covalently coupled to the soft segments, they inhibit plastic flow of the polymer chains, thus creating elastomeric resiliency.

By the term, “polymer” as used herein, it is meant a large molecule (macromolecule) composed of repeating structural units typically connected by covalent chemical bonds. The term, “polymer” as used herein refers to, but is not limited to, oligomers, homopolymers, copolymers, and mixtures thereof. By the term, “prepolymer” as used herein, it is meant a polymer of relatively low to medium molecular weight that is normally the intermediate material between a monomer and final polymer, and which may be further polymerized by reaction with cross-linking agents or chain extenders. By the term, “isocyanate compound” as used herein, it is meant any aliphatic or aromatic isocyanate containing two or more isocyanate functional groups. The isocyanate compounds can be monomers or monomeric units, because they can be polymerized to produce polymeric isocyanates containing two or more monomeric isocyanate repeat units. The isocyanate compound may have any suitable backbone chain structure including saturated or unsaturated, and linear, branched, or cyclic. By the term, “polyamine” as used herein, it is meant any aliphatic or aromatic compound containing two or more primary or secondary amine functional groups. The polyamine compound may have any suitable backbone chain structure including saturated or unsaturated, and linear, branched, or cyclic. The term “polyamine” may be used interchangeably with amine-terminated component. By the term, “polyol” as used herein, it is meant any aliphatic or aromatic compound containing two or more hydroxyl functional groups. The term “polyol” may be used interchangeably with hydroxy-terminated component.

Thermoplastic polyurethanes have minimal cross-linking; any bonding in the polymer network is primarily through hydrogen bonding or other physical mechanism. Because of their lower level of cross-linking, thermoplastic polyurethanes are relatively flexible. The cross-linking bonds in thermoplastic polyurethanes can be reversibly broken by increasing temperature such as during molding or extrusion. That is, the thermoplastic material softens when exposed to heat and returns to its original condition when cooled. On the other hand, thermoset polyurethanes become irreversibly set when they are cured. The cross-linking bonds are irreversibly set and are not broken when exposed to heat. Thus, thermoset polyurethanes, which typically have a high level of cross-linking, are relatively rigid.

Any suitable isocyanate compound can be used in accordance with this invention. For example, the isocyanate compound can be selected from the group consisting of isophorone diisocyanate (IPDI); 1,6-hexamethylene diisocyanate (HDI); 1,4, cyclohexyl diisocyanate (CHDI); 4,4′-diisocyanatodicyclohexylmethane diisocyanate (H₁₂MDI); 4,4′-diphenylmethane diisocyanate (MDI); 2,4-toluene diisocyanate (TDI); 2,6-toluene diisocyanate; trimethyl hexamethylene diisocyanate (TMDI); 3,3′-dimethyl-4,4′-biphenyl diisocyanate (TODD; p-phenylene diisocyanate (PPDI); dodecane diisocyanate (C₁₂DI); m-tetramethylene xylene diisocyanate (TMXDI); 1,4-benzene diisocyanate; trans-cyclohexane-1,4-diisocyanate; 1,5-naphthalene diisocyanate (NDI); 4,6-xylene diisocyanate (XDI); and mixtures thereof.

Aromatic polyurethanes can be prepared in accordance with this invention and these materials are preferably formed by reacting an aromatic diisocyanate with a polyol. Suitable aromatic diisocyanates that may be used in accordance with this invention include, for example, toluene 2,4-diisocyanate (TDI), toluene 2,6-diisocyanate (TDI), 4,4′-methylene diphenyl diisocyanate (MDI), 2,4′-methylene diphenyl diisocyanate (MDI), polymeric methylene diphenyl diisocyanate (PMDI), p-phenylene diisocyanate (PPDI), m-phenylene diisocyanate (PDI), naphthalene 1,5-diisocynate (NDI), naphthalene 2,4-diisocyanate (NDI), p-xylene diisocyanate (XDI), and homopolymers and copolymers and blends thereof. The aromatic isocyanates are able to react with the hydroxyl or amine compounds and form a durable and tough polymer having a high melting point. The resulting polyurethane generally has good mechanical strength and cut/shear-resistance.

Aliphatic polyurethanes also can be prepared in accordance with this invention and these materials are preferably formed by reacting an aliphatic diisocyanate with a polyol. Suitable aliphatic diisocyanates that may be used in accordance with this invention include, for example, isophorone diisocyanate (IPDI), 1,6-hexamethylene diisocyanate (HDI), 4,4′-dicyclohexylmethane diisocyanate (“H₁₂ MDI”), meta-tetramethylxylene diisocyanate (TMXDI), trans-cyclohexane diisocyanate (CHDI), and homopolymers and copolymers and blends thereof. Particularly suitable multi-functional isocyanates include trimers of HDI or H₁₂ MDI, oligomers, or other derivatives thereof. The resulting polyurethane generally has good light and thermal stability.

Any polyol available to one of ordinary skill in the art is suitable for use according to the invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG) which is particularly preferred, polyethylene propylene glycol, polyoxypropylene glycol, and mixtures thereof. The hydrocarbon chain can have saturated or unsaturated bonds and substituted or unsubstituted aromatic and cyclic groups. In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups. In still another embodiment, polycaprolactone polyols are included in the materials of the invention. Suitable polycaprolactone polyols include, but are not limited to: 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups. In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

Formation of Hydroxyl-Terminated Adduct

In the present invention, a polyurethane prepolymer is formed using a hydroxyl-terminated adduct. In one embodiment, the process involves first reacting a first isocyanate compound with a stoichiometric excess of polyol compound to form the hydroxyl-terminated adduct. The resulting hydroxyl-terminated adduct contains some unreacted hydroxyl groups. That is, there is a stoichiometric excess of hydroxyl groups. Preferably, the ratio of OH:NCO groups is in the range of about 1:0.66 to about 1:0.85, more preferably in the range of about 1:0.74 to about 1:0.85. Such hydroxyl-terminated adducts and methods for preparing such adducts are described in Illers et al., U.S. Pat. Nos. 4,098,773 and 4,191,818, the disclosures of which are hereby incorporated by reference. The resulting hydroxyl-terminated adduct can be used to prepare a prepolymer in accordance with this as discussed below.

Formation of Prepolymer

The hydroxyl-terminated adduct is reacted with a stoichiometric excess of a second isocyanate compound to form a polyurethane prepolymer. In one preferred embodiment, the hydroxyl-terminated adduct is added to a reaction vessel containing a stoichiometric excess of the second isocyanate compound. The reaction is conducted until substantially all of the hydroxyl groups of the hydroxyl-terminated adduct have reacted with the isocyanate groups of the second isocyanate compound. In the reaction, the adduct is end-capped with the isocyanate groups. The reaction produces an isocyanate-terminated prepolymer. It should be understood that the first and second isocyanate compounds used in the process of this invention may be the same or different chemical compounds.

As a result of the reaction between the isocyanate and polyol compounds, there will be some unreacted NCO groups in the polyurethane prepolymer. The prepolymer should have no greater than about 15% unreacted NCO groups based on total weight of prepolymer. Preferably, the prepolymer has no greater than about 12% unreacted NCO groups, more preferably from about 1% to about 8% NCO groups based on total weight of prepolymer. As the weight percent of unreacted isocyanate groups increases, the hardness of the composition also generally increases.

Chain-Extending of Prepolymer

The resulting isocyanate-terminated prepolymer can be reacted with a chain extender (curing agent). In general, the polyurethane prepolymer is reacted with hydroxyl-terminated curing agents to form the polyurethane composition. Suitable chain extenders are described in more detail below. The chain extenders extend the chain length of the prepolymer and build-up its molecular weight. The resulting polyurethane polymer has good elastomeric properties, because of its “hard” and “soft” segments, which are covalently bonded together. The soft, amorphous, low-melting point segments, which are formed from the polyols, are relatively flexible and mobile; while the hard, high-melting point segments, which are formed from the isocyanate and chain extenders, are relatively stiff and immobile. Manipulating the separation of hard and soft segments can impact the properties of the polyurethane polymer. Physical properties such as, for example, heat-resistance, shear durability, and elongation can be altered while maintaining the hardness of the polymer. In particular, the final polyurethane polymer of this invention has high thermal stability properties.

The resulting polyurethane composition can be used to form a golf ball cover in accordance with the present invention. The cover layer provides the ball with high impact durability and cut-, shear- and tear-resistance levels. In addition, the cover, in combination with the core layer, helps impart high resiliency to the golf balls. Preferably, the finished golf ball has a Coefficient of Restitution (CoR) of at least 0.750 and more preferably at least 0.800. Also, the finished golf ball preferably has a compression of between about 40 and about 110. These properties allow players to generate greater ball velocity off the tee and achieve greater distance with their drives. The polyurethane cover layer has high impact durability and thermal stability. At the same time, the cover layer provides a player with a comfortable and natural feeling when striking the ball with a club. The ball is easy to play and the ball's flight path can be controlled easily.

The polyurethane compositions used to make the golf ball covers of this invention can be formed by chain-extending the polyurethane prepolymer with a single chain-extender or blend of chain-extenders as described further below. In general, the prepolymer can be reacted with hydroxyl-terminated curing agents, amine-terminated curing agents, and mixtures thereof. The curing agents extend the chain length of the prepolymer and build-up its molecular weight. In general, thermoplastic polyurethane compositions are typically formed by reacting the isocyanate blend and polyols at a 1:1 stoichiometric ratio. Thermoset compositions, on the other hand, are cross-linked polymers and are typically produced from the reaction of the isocyanate blend and polyols at normally a 1.05:1 stoichiometric ratio.

A catalyst can be employed to promote the reaction between the isocyanate and polyol compounds for producing the prepolymer or between prepolymer and chain-extender during the chain-extending step. Preferably, the catalyst is added to the reactants before producing the prepolymer. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The catalyst is preferably added in an amount sufficient to catalyze the reaction of the components in the reactive mixture. In one embodiment, the catalyst is present in an amount from about 0.001 percent to about 1 percent, and preferably 0.1 to 0.5 percent, by weight of the composition.

The hydroxyl chain-extending (curing) agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy) ethoxy]cyclohexane; 1,3-bis-{2-[2-(2-hydroxyethoxy) ethoxy]ethoxy}cyclohexane; trimethylolpropane; polytetramethylene ether glycol (PTMEG), preferably having a molecular weight from about 250 to about 3900; and mixtures thereof.

Suitable amine chain-extending (curing) agents that can be used in chain-extending the polyurethane prepolymer include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-) toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benzeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”); and mixtures thereof. One particularly suitable amine-terminated chain-extending agent is Ethacure 300™ (dimethylthiotoluenediamine or a mixture of 2,6-diamino-3,5-dimethylthiotoluene and 2,4-diamino-3,5-dimethylthiotoluene.) The amine curing agents used as chain extenders normally have a cyclic structure and a low molecular weight (250 or less).

When the polyurethane prepolymer is reacted with hydroxyl-terminated curing agents during the chain-extending step, as described above, the resulting polyurethane composition contains urethane linkages. On the other hand, when the polyurethane prepolymer is reacted with amine-terminated curing agents during the chain-extending step, any excess isocyanate groups in the prepolymer will react with the amine groups in the curing agent. The resulting polyurethane composition contains urethane and urea linkages and may be referred to as a polyurethane/urea hybrid. The concentration of urethane and urea linkages in the hybrid composition may vary. In general, the hybrid composition may contain a mixture of about 10 to 90% urethane and about 90 to 10% urea linkages.

More particularly, when the polyurethane prepolymer is reacted with hydroxyl-terminated curing agents during the chain-extending step, as described above, the resulting composition is essentially a pure polyurethane composition containing urethane linkages having the following general structure:

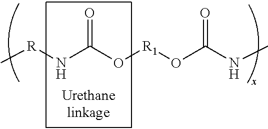

where x is the chain length, i.e., about 1 or greater, and R and R₁ are straight chain or branched hydrocarbon chain having about 1 to about 20 carbons.

However, when the polyurethane prepolymer is reacted with an amine-terminated curing agent during the chain-extending step, any excess isocyanate groups in the prepolymer will react with the amine groups in the curing agent and create urea linkages having the following general structure:

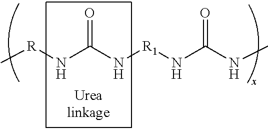

where x is the chain length, i.e., about 1 or greater, and R and R₁ are straight chain or branched hydrocarbon chain having about 1 to about 20 carbons.

Alternatively, a one-shot process can be used, wherein the hydroxyl-terminated adduct is mixed with the isocyanate compound and hydroxyl-terminated chain-extender (curing agent). For example, the hydroxyl-terminated adduct and hydroxyl-terminated chain extender can be added to a reaction vessel and then an isocyanate compound can be added to the reaction vessel, wherein all of the components are mixed together. In general, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

The polyurethane compositions used to form the cover layer may contain other polymer materials including, for example: aliphatic or aromatic polyurethanes, aliphatic or aromatic polyureas, aliphatic or aromatic polyurethane/urea hybrids, olefin-based copolymer ionomer compositions, polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax®, thermoplastic polyether block amides, available from Arkema Inc; cross-linked trans-polyisoprene and blends thereof; polyester-based thermoplastic elastomers, such as Hytrel®, available from DuPont; polyurethane-based thermoplastic elastomers, such as Elastollan®, available from BASF; polycarbonate/polyester blends such as Xylex®, available from SABIC Innovative Plastics; maleic anhydride-grafted polymers such as Fusabond®, available from DuPont, and mixtures of the foregoing materials.

In addition, the polyurethane compositions may contain fillers, additives, and other ingredients that do not detract from the properties of the final composition. These additional materials include, but are not limited to, catalysts, wetting agents, coloring agents, optical brighteners, cross-linking agents, whitening agents such as titanium dioxide and zinc oxide, ultraviolet (UV) light absorbers, hindered amine light stabilizers, defoaming agents, processing aids, surfactants, and other conventional additives. Other suitable additives include antioxidants, stabilizers, softening agents, plasticizers, including internal and external plasticizers, impact modifiers, foaming agents, density-adjusting fillers, reinforcing materials, compatibilizers, and the like. Some examples of useful fillers include zinc oxide, zinc sulfate, barium carbonate, barium sulfate, calcium oxide, calcium carbonate, clay, tungsten, tungsten carbide, silica, and mixtures thereof. Rubber regrind (recycled core material) and polymeric, ceramic, metal, and glass microspheres also may be used. Generally, the additives will be present in the composition in an amount between about 1 and about 70 weight percent based on total weight of the composition depending upon the desired properties.

Molding Methods

As discussed above, in the present invention, a polyurethane composition is used to form the outer cover of the golf ball. The polyurethane cover may be formed around the golf ball sub-assembly by dispensing polymeric material into the mold cavities and mating them together under sufficient heat and pressure. By the term, “sub-assembly” as used herein, it is meant the inner ball, that is the core and any intermediate layer(s) disposed between the core and outer cover layer. The core and intermediate layers are described in further detail below.

Different molding operations can be used to form the polyurethane cover over the core or sub-assembly of the ball. For example, compression-molding, casting, and injection-molding processes can be use. These molding processes normally use molds having an upper mold cavity and lower mold cavity. Each mold cavity is hemispherical-shaped and one-half of the size of a finished ball. The mold cavities have interior walls with details defining the dimple pattern of the cover that will be produced. The upper and lower mold cavities are joined together under sufficient heat and pressure. The polyurethane material in the cavities encapsulates the ball subassembly and forms the cover of the ball. In one embodiment, the polyurethane composition is in generally liquid form so that it can be dispensed into the mold cavities and molded over the golf ball sub-assembly. The molding process of this invention is suitable for making thin outer cover layers. Particularly, covers having a thickness of less than 0.05 inches can be made, more preferably in the range of 0.015 to 0.045 inches.

More particularly, in one embodiment of a liquid casting process, the polyurethane prepolymer and curing agent can be mixed in a motorized mixer inside a mixing head by metering amounts of the curative and prepolymer through the feed lines. The preheated lower mold cavities can be filled with the reactive polyurethane and curing agent mixture. Likewise, the preheated upper mold cavities can be filled with the reactive mixture. The lower and upper mold cavities are filled with substantially the same amount of reactive mixture. After the reactive mixture has resided in the lower mold cavities for a sufficient time period, typically about 40 to about 100 seconds, the golf ball subassembly can be lowered at a controlled speed into the reacting mixture. Ball cups can hold the subassemblies by applying reduced pressure (or partial vacuum). After sufficient gelling (typically about 4 to about 12 seconds), the vacuum can be removed and the subassembly can be released. Then, the upper half-molds can be mated with the lower half-molds. An exothermic reaction occurs when the polyurethane prepolymer and curing agent are mixed and this continues until the material solidifies around the subassembly. The molded balls can then be cooled in the mold and removed when the molded cover layer is hard enough to be handled without deforming. This molding technique is described in the above-mentioned Hebert et al., U.S. Pat. No. 6,132,324 along with Wu, U.S. Pat. No. 5,334,673 and Brown et al., U.S. Pat. No. 5,006,297, the disclosures of which are hereby incorporated by reference.

In another embodiment, thermoplastic polyurethane pellets can be molded into the cover using retractable pin injection-molding (RPIM) methods. These methods generally involve using upper and lower mold cavities that are mated together. The upper and lower mold cavities form a spherical interior cavity when they are joined together. The mold cavities used to form the outer cover layer have interior dimple cavity details. The cover material conforms to the interior geometry of the mold cavities to form a dimple pattern on the surface of the ball. The injection-mold includes retractable support pins positioned throughout the mold cavities. The retractable support pins move in and out of the cavity. The support pins help maintain the position of the core or ball sub-assembly while the molten composition flows through the mold gates. The molten composition flows into the cavity between the core and mold cavities to surround the core and form the cover layer. Other methods can be used to make the cover including, for example, reaction injection-molding (RIM), liquid injection-molding, casting, spraying, powder-coating, vacuum-forming, flow-coating, dipping, spin-coating, and the like.

Prior to forming the cover layer, the ball subassembly may be surface-treated to increase the adhesion between its outer surface and cover material. Examples of such surface-treatment may include mechanically or chemically abrading the outer surface of the subassembly. Additionally, the subassembly may be subjected to corona discharge, plasma treatment, silane dipping, or other chemical treatment methods known to those of ordinary skill in the art prior to forming the cover around it. Other layers of the ball, for example, the core and cover layers, also may be surface-treated. Examples of these and other surface-treatment techniques can be found in U.S. Pat. No. 6,315,915, the disclosure of which is hereby incorporated by reference.

A dispensing process as described in U.S. Pat. Nos. 7,655,171; 7,490,975; and 7,246,937, the disclosures of which are hereby incorporated by reference, can be used in accordance with the present invention. This process involves pumping the reactive polyurethane components into a mixer body and mixing them together with a dynamic mixer element. The components are heated to a temperature in the range of about 150° F. to about 350° F. as the components flow through a dispensing port, which dispenses the components into the lower and upper half-molds. The dispensing port moves into and out of the mold cavity by pneumatic pressure so the components are deposited uniformly into the half-molds.

After the golf balls have been removed from the mold, they may be subjected to finishing steps such as flash trimming, surface-treatment, marking, coating, and the like using techniques known in the art.

Core and Intermediate Layers

As discussed above, the core and intermediate layer(s), if any are present, constitute the sub-assembly of the ball or inner ball which is encapsulated by the cover material. The core and intermediate layers may be made of a wide variety of thermoset and thermoplastic materials.

Preferably, the core is made of a thermoset rubber composition. Suitable thermoset rubber materials that may be used to form the inner core include, but are not limited to, polybutadiene, polyisoprene, ethylene propylene rubber (“EPR”), ethylene-propylene-diene (“EPDM”) rubber, styrene-butadiene rubber, styrenic block copolymer rubbers (such as “SI”, “SIS”, “SB”, “SBS”, “SIBS”, and the like, where “S” is styrene, “l” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and blends of two or more thereof. More preferably, the inner core is formed from a polybutadiene rubber composition.

The thermoset rubber composition may be cured using conventional curing processes. Suitable curing processes include, for example, peroxide-curing, sulfur-curing, high-energy radiation, and combinations thereof. Radical scavengers such as a halogenated organosulfur, organic disulfide, or inorganic disulfide compounds may be added to the rubber composition. These compounds also may function as “soft and fast agents.” The rubber composition also may include filler(s) such as materials selected from carbon black, clay and nanoclay particles, talc (e.g., Luzenac HAR® high aspect ratio talcs, commercially available from Luzenac America, Inc.), glass (e.g., glass flake, milled glass, and microglass), mica and mica-based pigments (e.g., Iriodin® pearl luster pigments, commercially available from The Merck Group), and combinations thereof. In addition, the rubber compositions may include antioxidants. Also, processing aids such as high molecular weight organic acids and salts thereof may be added to the composition. In another embodiment, foaming (blowing) agents are added to the rubber composition and the rubber composition is foamed.

One or more intermediate layers can be molded over the inner core. These intermediate layers also can be referred to as outer core, casing, or inner cover layers. In one embodiment, as described above, the intermediate layer is made of a second thermoset rubber composition. Thus, a dual-layered core having a first layer made of a thermoset rubber and a second layer made of a thermoset rubber can be made. A cover composition can be molded over this ball sub-assembly in accordance with this invention. In another embodiment, a thermoplastic composition is used to form the intermediate layer. Thus, in this embodiment, a dual-layered core having a first layer made of a thermoset rubber and a second layer made of a thermoplastic composition is made.

Different thermoplastic compositions can be used. For example, the intermediate layer may be made from an ethylene acid copolymer ionomer composition. Suitable ionomer compositions include partially-neutralized ionomers and highly-neutralized ionomers (HNPs), including ionomers formed from blends of two or more partially-neutralized ionomers, blends of two or more highly-neutralized ionomers, and blends of one or more partially-neutralized ionomers with one or more highly-neutralized ionomers. For purposes of the present disclosure, “HNP” refers to an acid copolymer after at least 70% of all acid groups present in the composition are neutralized. The composition used to make the intermediate layer can include additives, for example, fillers, cross-linking agents, chain extenders, surfactants, dyes and pigments, coloring agents, fluorescent agents, adsorbents, stabilizers, softening agents, impact modifiers, antioxidants, antiozonants, and the like. In another embodiment, foaming (blowing) agents are added to the thermoplastic or thermoset composition used to make the inner cover layer, and the composition is foamed.

Preferred ionomers are salts of O/X- and O/X/Y-type acid copolymers, wherein O is an α-olefin, X is a C₃-C₈ α,β-ethylenically unsaturated carboxylic acid, and Y is a softening monomer. O is preferably selected from ethylene and propylene. X is preferably selected from methacrylic acid, acrylic acid, ethacrylic acid, crotonic acid, and itaconic acid. Methacrylic acid and acrylic acid are particularly preferred. Y is preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate.

Preferred O/X and O/X/Y-type copolymers include, without limitation, ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymers, and the like. The term, “copolymer,” as used herein, includes polymers having two types of monomers, those having three types of monomers, and those having more than three types of monomers. Preferred a, O-ethylenically unsaturated mono- or dicarboxylic acids are (meth) acrylic acid, ethacrylic acid, maleic acid, crotonic acid, fumaric acid, itaconic acid. (Meth) acrylic acid is most preferred. As used herein, “(meth) acrylic acid” means methacrylic acid and/or acrylic acid. Likewise, “(meth) acrylate” means methacrylate and/or acrylate.

Other suitable thermoplastic polymers that may be used to form the intermediate layer include, but are not limited to, the following polymers (including homopolymers, copolymers, and derivatives thereof); (a) polyesters, particularly those modified with a compatibilizing group such as sulfonate or phosphonate, including modified poly(ethylene terephthalate), modified poly(butylene terephthalate), modified poly(propylene terephthalate), modified poly(trimethylene terephthalate), modified poly(ethylene naphthenate), and those disclosed in U.S. Pat. Nos. 6,353,050, 6,274,298, and 6,001,930, the entire disclosures of which are hereby incorporated herein by reference, and blends of two or more thereof; (b) polyamides, polyamide-ethers, and polyamide-esters, and those disclosed in U.S. Pat. Nos. 6,187,864, 6,001,930, and 5,981,654, the entire disclosures of which are hereby incorporated herein by reference, and blends of two or more thereof; (c) polyurethanes, polyureas, polyurethane-polyurea hybrids, and blends of two or more thereof; (d) fluoropolymers, such as those disclosed in U.S. Pat. Nos. 5,691,066, 6,747,110 and 7,009,002, the entire disclosures of which are hereby incorporated herein by reference, and blends of two or more thereof; (e) polystyrenes, such as poly(styrene-co-maleic anhydride), acrylonitrile-butadiene-styrene, poly(styrene sulfonate), polyethylene styrene, and blends of two or more thereof; (f) polyvinyl chlorides and grafted polyvinyl chlorides, and blends of two or more thereof; (g) polycarbonates, blends of polycarbonate/acrylonitrile-butadiene-styrene, blends of polycarbonate/polyurethane, blends of polycarbonate/polyester, and blends of two or more thereof; (h) polyethers, such as polyarylene ethers, polyphenylene oxides, block copolymers of alkenyl aromatics with vinyl aromatics and polyamicesters, and blends of two or more thereof; (i) polyimides, polyetherketones, polyamideimides, and blends of two or more thereof; and (j) polycarbonate/polyester copolymers and blends.

The intermediate layer also may be referred to as a casing, mantle, or inner cover layer. In one example, a golf ball having inner and outer cover layers may be made. The multi-layered cover of the golf balls of this invention provide the ball with good impact durability, toughness, and wear-resistance. In general, the hardness and thickness of the different cover layers may vary depending upon the desired ball construction.

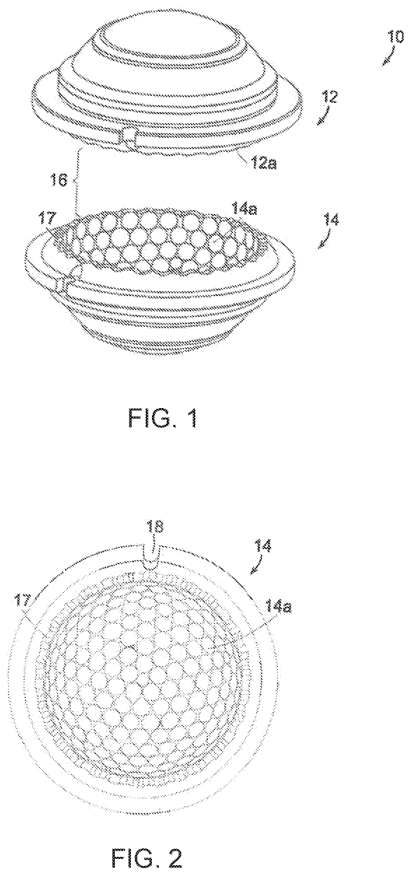

As discussed above, in one embodiment as shown in FIG. 1, a golf ball mold (10) is used to form the polyurethane cover over the ball sub-assembly. The mold (10) includes hemispherical mold cavities (12) and (14) having interior dimple patterns (12a) and (14a). When the mold cavities (12, 14) are mated, they define an interior spherical cavity (16) to form the cover for the ball. The mold cavities (12, 14) are mated together along a parting line (17) that creates an equator or seam for the finished ball. In FIG. 2, the mold cavity (14) is shown in further detail. The mold cavity (14) includes a dimple pattern (14a) and locator slot (18) that fits over a locator pin on a mold frame (not shown) when the mold cavity (14) is inserted into the frame.

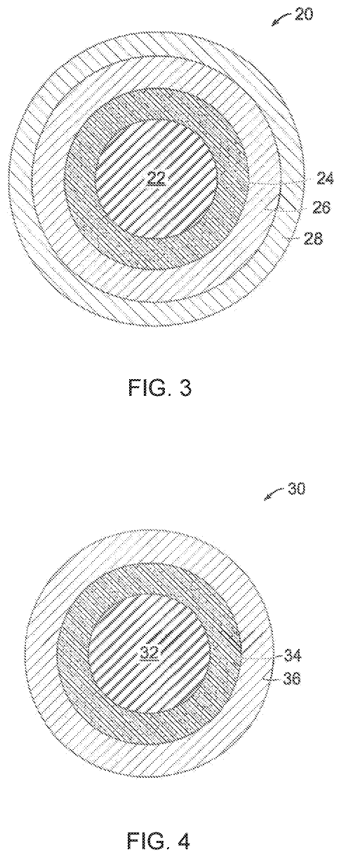

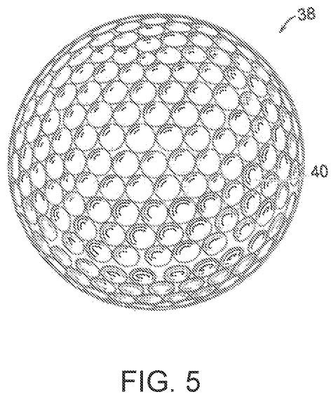

Referring to FIG. 3, one version of a four-piece golf ball that can be made in accordance with this invention is generally indicated at (20). The ball (20) contains an inner core (center) (22) and surrounding intermediate layers (24) and (26), which also can be referred to as the outer core and inner cover layers, respectively. This ball sub-assembly is encapsulated by a polyurethane outer cover (28) made in accordance with the present invention. Referring to FIG. 4, in another version, a three-piece golf ball (30) contains an inner core (center) (32) and outer core layer (34). Thus, the core is dual-layered. This core sub-assembly is surrounded by a single-layered polyurethane cover (36) made in accordance with this invention. In FIG. 5, a finished golf ball (38) having a dimpled polyurethane cover (40) made in accordance with this invention. Various patterns and geometric shapes of the dimples (40) can be used to modify the aerodynamic properties of the golf ball.

Different golf ball constructions can be made in accordance with FIGS. 1-5 discussed above. Such golf ball constructions include, for example, two-piece, three-piece, four-piece, and five-piece constructions. It should be understood the golf balls shown in FIGS. 1-5 are for illustrative purposes only, and they are not meant to be restrictive. Other golf ball constructions can be made in accordance with this invention.

In one example, the inner cover layer hardness is about 15 Shore D or greater, more preferably about 25 Shore D or greater, and most preferably about 35 Shore D or greater. For example, the inner cover layer hardness may be in the range of about 15 to about 60 Shore D, and more preferably about 27 to about 48 Shore D. In another version, the inner cover layer hardness is about 50 Shore D or greater, preferably about 55 Shore D or greater, and most preferably about 60 Shore D or greater. For example, in one version, the inner cover has a Shore D hardness of about 55 to about 90 Shore D. In another embodiment, the inner cover has a Shore D hardness of about 60 to about 78 Shore D, and in yet another version, the inner cover has a Shore D hardness of about 64 to about 72 Shore D. More particularly, in one example, the inner cover has a hardness of about 65 Shore D or greater. The hardness of the inner cover layer is measured per the methods described further below. In addition, the thickness of the inner cover layer is preferably about 0.015 inches to about 0.100 inches, more preferably about 0.020 inches to about 0.080 inches, and most preferably about 0.030 inches to about 0.050 inches. Typically, the thickness of the inner cover is about 0.035 or 0.040 or 0.045 inches.

Concerning the outer cover layer, this layer may be relatively thin. The outer cover preferably has a thickness within a range having a lower limit of 0.004 or 0.006 or 0.008 and an upper limit of 0.010 or 0.020 or 0.030 or 0.040 inches. Preferably, the thickness of the outer cover is about 0.016 inches or less, more preferably 0.008 inches or less. The outer cover preferably has a material hardness of 80 Shore D or less, or 70 Shore D or less, or 60 Shore D or less, or 55 Shore D or less, or 50 Shore D or less, or 45 Shore D or less. In one example, the outer cover preferably has a Shore D hardness in the range of about 50 to about 80, more preferably about 55 to about 75. In another example, the outer cover preferably has a Shore D hardness in the range of about 10 to about 70, more preferably about 15 to about 60. The hardness of the inner and outer cover layers may be measured per the methods described below.

The hardness of a cover layer may be measured on the surface or midpoint of the given layer in a manner similar to measuring the hardness of a core layer as described further below. For example, the hardness of the inner cover layer may be measured at the surface or midpoint of the layer. A midpoint hardness measurement is preferably made for the inner and intermediate cover layers. The midpoint hardness of a cover layer is taken at a point equidistant from the inner surface and outer surface of the layer to be measured. Once one or more cover or other ball layers surround a layer of interest, the exact midpoint may be difficult to determine, therefore, for the purposes of the present invention, the measurement of “midpoint” hardness of a layer is taken within plus or minus 1 mm of the measured midpoint of the layer. A surface hardness measurement is preferably made for the outer cover layer. In these instances, the hardness is measured on the outer surface (cover) of the ball. Methods for measuring the hardness are described in detail below under “Test Methods.”

Test Methods

Hardness: The center hardness of a core is obtained according to the following procedure. The core is gently pressed into a hemispherical holder having an internal diameter approximately slightly smaller than the diameter of the core, such that the core is held in place in the hemispherical portion of the holder while concurrently leaving the geometric central plane of the core exposed. The core is secured in the holder by friction, such that it will not move during the cutting and grinding steps, but the friction is not so excessive that distortion of the natural shape of the core would result. The core is secured such that the parting line of the core is roughly parallel to the top of the holder. The diameter of the core is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the center of the core is found with a center square and carefully marked and the hardness is measured at the center mark according to ASTM D-2240. Additional hardness measurements at any distance from the center of the core can then be made by drawing a line radially outward from the center mark, and measuring the hardness at any given distance along the line, typically in 2 mm increments from the center. The hardness at a particular distance from the center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of a golf ball layer is measured on the actual outer surface of the layer and is obtained from the average of a number of measurements taken from opposing hemispheres, taking care to avoid making measurements on the parting line of the core or on surface defects, such as holes or protrusions. Hardness measurements are made pursuant to ASTM D-2240 “Indentation Hardness of Rubber and Plastic by Means of a Durometer.” Because of the curved surface, care must be taken to ensure that the golf ball or golf ball sub-assembly is centered under the durometer indenter before a surface hardness reading is obtained. A calibrated, digital durometer, capable of reading to 0.1 hardness units is used for the hardness measurements. The digital durometer must be attached to, and its foot made parallel to, the base of an automatic stand. The weight on the durometer and attack rate conforms to ASTM D-2240.

In certain embodiments, a point or plurality of points measured along the “positive” or “negative” gradients may be above or below a line fit through the gradient and its outermost and innermost hardness values. In an alternative preferred embodiment, the hardest point along a particular steep “positive” or “negative” gradient may be higher than the value at the innermost portion of the inner core (the geometric center) or outer core layer (the inner surface)—as long as the outermost point (i.e., the outer surface of the inner core) is greater than (for “positive”) or lower than (for “negative”) the innermost point (i.e., the geometric center of the inner core or the inner surface of the outer core layer), such that the “positive” and “negative” gradients remain intact.

As discussed above, the direction of the hardness gradient of a golf ball layer is defined by the difference in hardness measurements taken at the outer and inner surfaces of a particular layer. The center hardness of an inner core and hardness of the outer surface of an inner core in a single-core ball or outer core layer are readily determined according to the test procedures provided above. The outer surface of the inner core layer (or other optional intermediate core layers) in a dual-core ball are also readily determined according to the procedures given herein for measuring the outer surface hardness of a golf ball layer, if the measurement is made prior to surrounding the layer with an additional core layer. Once an additional core layer surrounds a layer of interest, the hardness of the inner and outer surfaces of any inner or intermediate layers can be difficult to determine. Therefore, for purposes of the present invention, when the hardness of the inner or outer surface of a core layer is needed after the inner layer has been surrounded with another core layer, the test procedure described above for measuring a point located 1 mm from an interface is used. Likewise, the midpoint of a core layer is taken at a point equidistant from the inner surface and outer surface of the layer to be measured, most typically an outer core layer. Once again, once one or more core layers surround a layer of interest, the exact midpoint may be difficult to determine, therefore, for the purposes of the present invention, the measurement of “midpoint” hardness of a layer is taken within plus or minus 1 mm of the measured midpoint of the layer.

Also, it should be understood that there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers. It also should be understood that the two measurement techniques are not linearly related and, therefore, one hardness value cannot easily be correlated to the other. Shore hardness (for example, Shore C or Shore D hardness) was measured according to the test method ASTM D-2240.

The present invention is illustrated further by the following Examples, but these Examples should not be construed as limiting the scope of the invention.

### EXAMPLES

The following Prophetic Examples describe polyurethane compositions that can be used to make golf ball covers in accordance with this invention. The core and intermediate layers of the golf ball can be made from any suitable thermoset or thermoplastic composition. For example, a polybutadiene rubber composition can be used to make the inner core; and an ethylene acid copolymer ionomer composition can be used to make the intermediate layer.

### Example 1

In this example, polytetramethylene ether glycol (PTMEG) was reacted with Mondurrm MLQ (a mixture of 4,4′-methylene diphenyl diisocyanate (MDI), 2,4′-methylene diphenyl diisocyanate (MDI)) to form an OH-terminated adduct. This adduct was then reacted with Mondur MLQ (a mixture of 4,4′-methylene diphenyl diisocyanate (MDI), 2,4′-methylene diphenyl diisocyanate (MDI), available from Covestro, Baytown, Tx USA) to form an isocyanate-terminated prepolymer. The resulting polyurethane prepolymer contained 43.08% MLQ and 56.92% PTMEG. Then, the isocyanate-terminated prepolymer was treated with 1,4-butanediol, to form the polyurethane polymer. The polyurethane composition had high thermal stability properties.

### Comparative Example A

A conventional prepolymer was prepared by reacting polytetramethylene ether glycol (PTMEG) with Mondurrm MLQ (a mixture of 4,4′-methylene diphenyl diisocyanate (MDI), 2,4′-methylene diphenyl diisocyanate (MDI). The resulting polyurethane prepolymer contained 43.08% MLQ and 56.92% PTMEG. Then, the isocyanate-terminated prepolymer was treated with 1,4-butanediol, to form the polyurethane polymer. The polyurethane composition of this Comparative Example A had inferior thermal stability properties to the polyurethane composition made in above Example 1.

As shown in the above Example 1 and Comparative Example A, the process of the present invention can be used to form a polyurethane polymer having the same building blocks as traditionally made polyurethane polymers. (Both polyurethane prepolymers contain 43.08% MLQ and 56.92% PTMEG.) However, the polyurethane polymers of this invention have higher thermal stability properties over traditionally made polyurethane polymer. The polyurethane polymers of this invention tend to have longer hard segment portions which have a higher melting point and these segments increase the overall melting point of the polyurethane. These hard segments also tend to enhance the crystallinity of the polyurethane.

### Example 2

In this example, polytetramethylene ether glycol (PTMEG) was reacted with Desmodur® W (4,4′-diisocyanatodicyclohexylmethane (H₁₂MDI), available from Covestro) to form an OH-terminated adduct. This adduct was then reacted with Desmodur W to form an isocyanate-terminated prepolymer. The resulting polyurethane prepolymer contained 44.96% H₁₂MDI and 55.04% PTMEG. Then, the isocyanate-terminated prepolymer was treated with 1,4-butanediol, to form the polyurethane polymer. The polyurethane composition had high thermal stability properties.

### Example 3

In this example, polytetramethylene ether glycol (PTMEG) was reacted with Desmodur® W (4,4′-diisocyanatodicyclohexylmethane (H₁₂MDI)) to form an OH-terminated adduct. This adduct was then reacted with Desmodur N-3400™ (a homopolymer of hexamethylene diisocyanate (HDI), available from Covestro, Baytown, Tx, USA) to form an isocyanate-terminated prepolymer. The resulting polyurethane prepolymer contained 32.76% N-3400 and 67.24% PTMEG H₁₂MDI adduct. Then, the isocyanate-terminated prepolymer was treated with diethyltoluene diamine, to form the polyurethane polymer. The polyurethane composition had high thermal stability properties.

### Example 4

In this example, polytetramethylene ether glycol (PTMEG) was reacted with Mondur™ MLQ (a mixture of 4,4′-methylene diphenyl diisocyanate (MDI) and 2,4′-methylene diphenyl diisocyanate (MD1)) to form an OH-terminated adduct. This adduct was then reacted with Desmodur W™ to form an isocyanate-terminated prepolymer. The resulting polyurethane prepolymer contained 30.23% H₁₂MDI and 69.77% PTMEG-MLQ adduct. Then, the isocyanate-terminated prepolymer was treated with 1,4-butanediol, to form the polyurethane polymer. The polyurethane composition had high thermal stability properties.

Thermal Stability

It is anticipated that the polyurethane compositions prepared as described in Examples 1-4 will have greater heat stability over Comparative Example A by a factor of about 25° to about 75° C. The thermal properties of the polyurethane elastomer produced by the process of the invention were tested by thermal mechanical analysis with a TMA QA400 available from TA Instruments. For this purpose, the test specimen may be taken from a golf ball or from a tensile bar, hardness button, sheet, or flex bar. The sample thickness should be 5 mm thick unless that thickness in not available i.e. a golf ball cover. The measurement is carried out in penetration mode with a weight of 100 grams and the specimen was simultaneously heated at a rate of 5 C/min. Softening of the specimen was measured by the penetration of the probe.

When numerical lower limits and numerical upper limits are set forth herein, it is contemplated that any combination of these values may be used. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention.

It also should be understood that the methods and golf ball products described and illustrated herein represent only presently preferred embodiments of the invention. It is appreciated by those skilled in the art that various changes and additions can be made to such methods and products without departing from the spirit and scope of this invention. It is intended that all such embodiments be covered by the appended claims.

We claim:

1. A method for forming a golf ball, comprising the steps of:
providing a golf ball sub-assembly comprising at least one core layer;
forming a hydroxyl-terminated adduct by reacting a first isocyanate compound with a stoichiometric excess of polyol compound;
forming an isocyanate-terminated prepolymer by reacting the hydroxyl-terminated adduct with a stoichiometric excess of a second isocyanate compound;
reacting the isocyanate-terminated prepolymer with a hydroxyl-terminated chain extender to form a polyurethane composition; and
forming a cover disposed about the core, the cover comprising the polyurethane composition.

2. The method of claim 1, wherein the first isocyanate compound is reacted with the polyol compound at a ratio OH:NCO groups in the range of about 1:0.66 to about 1:0.85.

3. The method of claim 1, wherein the isocyanate-terminated prepolymer has no greater than 15% unreacted NCO groups.

4. The method of claim 1, wherein the first and second isocyanate compounds are aliphatic isocyanates.

5. The method of claim 4, wherein the aliphatic isocyanates are selected from the group consisting of isophorone diisocyanate, 1,6-hexamethylene diisocyanate, 4,4′-dicyclohexylmethane diisocyanate, meta-tetramethylxylene diisocyanate, trans-cyclohexane diisocyanate, and homopolymers and copolymers and blends thereof.

6. The method of claim 1, wherein the first and second isocyanate compounds are aromatic isocyanates.

7. The method of claim 6, wherein the first and second aromatic isocyanates are selected from the group consisting of toluene 2,4-diisocyanate, toluene 2,6-diisocyanate, 4,4′-methylene diphenyl diisocyanate, 2,4′-methylene diphenyl diisocyanate, polymeric methylene diphenyl diisocyanate, p-phenylene diisocyanate, m-phenylene diisocyanate, naphthalene 1,5-diisocynate, naphthalene 2,4-diisocyanate, p-xylene diisocyanate, and homopolymers and copolymers and blends thereof.

8. The method of claim 1, wherein the first isocyanate compound is an aromatic isocyanate and the second isocyanate is an aliphatic isocyanate.

9. The method of claim 1, wherein the first isocyanate compound is an aliphatic isocyanate and the second isocyanate is an aromatic isocyanate.

10. The method of claim 1, wherein hydroxyl-terminated chain extender is selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy) ethoxy]cyclohexane; 1,3-bis-{2-[2-(2-hydroxyethoxy) ethoxy]ethoxy}cyclohexane; trimethylolpropane; and polytetramethylene ether glycol (PTMEG), and blends thereof.

11. The method of claim 10, wherein the chain extender is 1,4-butanediol.

12. The method of claim 1, wherein the polyurethane composition comprises an ultraviolet light stabilizer.

13. The method of claim 1, wherein a catalyst is used to promote the reaction between the isocyanate-terminated prepolymer with a hydroxyl-terminated chain extender.

14. The method of claim 1, wherein the polyurethane cover layer has a thickness in the range of about 0.010 to about 0.050 inches.

15. The method of claim 1, wherein the polyurethane cover layer has a hardness in the range of about 20 to about 60 Shore D.

16. The method of claim 1, wherein the polyurethane composition is a thermoset polyurethane composition.

17. The method of claim 1, wherein the polyurethane composition is a thermoplastic polyurethane composition.

18. A method for forming a golf ball, comprising the steps of:
providing a golf ball sub-assembly comprising at least one core layer;
forming a hydroxyl-terminated adduct by reacting a first isocyanate compound with a stoichiometric excess of polyol compound;
forming an isocyanate-terminated prepolymer by reacting the hydroxyl-terminated adduct with a stoichiometric excess of a second isocyanate compound;
providing a lower and upper mold cavity, each mold cavity having an arcuate inner surface defining an inverted dimple pattern;
dispensing a liquid mixture comprising the isocyanate-terminated prepolymer and hydroxyl-terminated chain-extender into the lower and upper mold cavities;
placing the ball-subassembly into the lower or upper mold cavity containing the liquid mixture;
bringing the lower and upper mold cavities together under sufficient pressure so the liquid mixture reacts and forms a polyurethane outer cover layer; and
detaching the mold cavities and removing the golf ball from the mold.

19. The method of claim 18, wherein the first isocyanate compound is reacted with the polyol compound at a ratio OH:NCO groups in the range of about 1:0.66 to about 1:0.85.

20. The method of claim 18, wherein the isocyanate-terminated prepolymer has no greater than 15% unreacted NCO groups.

21. A method for forming a golf ball, comprising the steps of:
providing a golf ball sub-assembly comprising at least one core layer;
forming a hydroxyl-terminated adduct by reacting a first isocyanate compound with a stoichiometric excess of polyol compound;
forming an isocyanate-terminated prepolymer by reacting the hydroxyl-terminated adduct with a stoichiometric excess of a second isocyanate compound;
reacting the isocyanate-terminated prepolymer with a hydroxyl-terminated chain extender to form a polyurethane composition;
providing a mold having a lower mold cavity and upper mold cavity, each mold cavity having an arcuate inner surface defining an inverted dimple pattern; so that when the upper and lower mold cavities are mated together, they define a mold having an interior spherical cavity for holding a golf ball sub-assembly;
loading the golf ball sub-assembly into the interior spherical cavity of the mold, wherein the mold further includes two or more retractable pins for holding the golf ball within the spherical cavity;
injecting the polyurethane composition into the spherical cavity to form a spherical cover over the golf ball sub-assembly; and
detaching the lower and upper mold cavities and removing the golf ball from the mold.

22. The method of claim 21, wherein the first isocyanate compound is reacted with the polyol compound at a ratio OH:NCO groups in the range of about 1:0.66 to about 1:0.85.

23. The method of claim 21, wherein the isocyanate-terminated prepolymer has no greater than 15% unreacted NCO groups.
